(19) United States
(12) Patent Application Publication
(10) Pub. No.: US 2016/0070950 A1
(43) Pub. Date: Mar. 10, 2016

(54) METHOD AND SYSTEM FOR AUTOMATICALLY ASSIGNING CLASS LABELS TO OBJECTS

(71) Applicant: AGENCY FOR SCIENCE, TECHNOLOGY AND RESEARCH, Singapore (SG)

(72) Inventor: Jinmiao CHEN, Singapore (SG)

(21) Appl. No.: 14/850,797

(22) Filed: Sep. 10, 2015

(30) Foreign Application Priority Data
Sep. 10, 2014 (SG) 10201405604S

(51) Int. Cl. G06K 9/00; G06T 7/00; G06T 5/40; G06K 9/62

(52) U.S. Cl. CPC G06K 9/00147; G06K 9/6256; G06K 9/628; G06T 7/0012; G06T 7/0085; G06T 5/40; G06T 2207/10056; G06T 2207/20081; G06T 2207/30242; G06T 2207/30004

(57) ABSTRACT

A method of automatically assigning class labels to objects is provided. The method uses object data indicative of a plurality of parameters associated with each object. The method comprises (i) identifying, from the object data or from a lower-dimensional encoding of the object data a plurality of cluster centres in a d-dimensional space, each cluster centre corresponding to one of the class labels; (ii) for respective cluster centres, determining a surrounding region based on a nearest neighbour cluster centre, and assigning the respective class label to objects within the surrounding region; (iii) generating a predictive model using the object data, or the lower-dimensional encoding of the object data and the class labels of the assigned objects; and (iv) assigning class labels to unassigned objects using the predictive model. A corresponding system for performing the above method is also provided.

### FIELD AND BACKGROUND

The present disclosure relates to a method and system for automatically assigning class labels to objects, for example but not limited to, a method and system for classification of cells from high-dimensional flow cytometry data or mass cytometry data.

Flow cytometry is technology commonly used for cell counting, cell sorting, biomarker detection and protein engineering. It has many applications in basic research, clinical practice and clinical trials such as analysis of cellular lineages and diagnosis of health disorders etc. For example, it can be used for delineating the phenotypic heterogeneity of cell populations in specific tissues.

Cell subset identification is one of the most critical step of mass cytometry (and flow cytometry) data analysis. This can be performed by manual gating using data analysis software such as FlowJo. However, the manual gating is subjective and laborious.

Alternatively, cell subset identification can be done by using automatic clustering methods provided by software such as flowMeans. flowMeans is a non-parametric approach to perform automated gating of cell populations in flow cytometry data. It is done by counting the number of modes in every single dimension followed by multidimensional clustering. Adjacent clusters in terms of Euclidean or Mahalanobis distance are merged and the number of clusters is determined using a change point detection algorithm based on a piecewise linear regression. Overall, this approach allows multiple clusters to represent the same population. By using the k-means algorithm, flowMeans avoids using complex statistical models. However, it is sensitive to the estimation of the number of clusters and outliers. Therefore, flowMeans is unable to segregate subsets (i.e. different cell populations) satisfactorily, especially for high dimensional data such as mass cytometry data.

ACCENSE is another automatic clustering method and is illustrated in FIG. 1. ACCENSE performs kernel density estimations 1 employing many different bandwidths (Bandwidth 1, 2, . . . n) and the corresponding peaks are detected. In other words, an exhaustive search 3 is performed to find an optimal bandwidth for the kernel density estimation 5. The optimal bandwidth is determined based on the number of peaks. At step 7, respective clusters are then defined by a circle of radius dk/2 centered at a peak k (dk represents a distance between the peak k and its nearest neighboring peak) and cells located within the circle is assigned to a cluster k. This approach results in a high computational requirement, which makes the processing speed very slow, and almost rendered inapplicable to data of a large size. In addition, ACCENSE is unable to detect the boundaries of clusters and leaves a significant number of cells with no cluster assignment. This can hamper the estimation of cell population frequencies as well as the downstream statistical comparisons in flow cytometry and mass cytometry data analysis.

Therefore, it is desirable to provide an improved method and system for assigning class labels to cells.

### SUMMARY

In general terms, the present disclosure proposes obtaining clustering information associated with object data to be classified and using the information to generate a predictive model to assign any unclassified/unassigned objects to respective clusters.

According to a first expression, there is provided a method of automatically assigning class labels to objects, using object data indicative of a plurality of parameters associated with each object, the method comprising:
(i) identifying, from the object data or from a lower-dimensional encoding of the object data, a plurality of cluster centres in a d-dimensional space, each cluster centre corresponding to one of the class labels;
(ii) for respective cluster centres, determining a surrounding region based on a nearest neighbor cluster centre, and assigning the respective class label to objects within the surrounding region;
(iii) generating a predictive model using the object data, or the lower-dimensional encoding of the object data, and the class labels of the assigned objects; and
(iv) assigning class labels to unassigned objects using the predictive model.

The above method is advantageous as it generates a predicative model based on object data obtained from a clustering method to perform class assignments of objects which are otherwise unclassifiable or difficult to be classified by the clustering method. The above method mitigates the problem of an inaccurate boundary detection associated with clustering algorithms by using the predicative model. Accordingly, this allows the clustering accuracy in terms of the segregation between distinct clusters as well as the cluster boundaries detection or estimation, to be achieved.

In particular, this may allow an improved segregation of cell subsets as well as and a precise detection of subset boundaries (represented by the cluster boundaries), thereby achieving an accurate estimation of subset frequencies from flow cytometry data or mass cytometry data. Typically, a cell subset comprises representative cells that are distinct from those of other subsets, and each cell subset may represent respective cell population or cell sub-population. In some embodiments, a density-based clustering algorithm is used to identify cluster centers together with the predictive model to estimate and refine the cluster boundaries to closely recapitulate the true subset boundaries.

The predicative model is typically generated by employing a machine learning algorithm. Nevertheless, as a whole, the method does not require any known class label to be assigned to the objects or cells prior to the classification. That is, it employs an un-supervised clustering method that is aided and improved by machine learning.

The cluster centres may be identified by: determining a kernel density estimate from the object data; and detecting peaks in the kernel density estimate, said peaks corresponding to the cluster centres.

In some embodiments, the method comprises prior to operation (i), applying dimensionality reduction to the object data to generate the lower-dimensional encoding of the object data. In one example, after the dimensionality reduction, the lower-dimensional encoding of the object data defines a 2-dimensional space.

In some embodiments, the surrounding region is determined by determining a distance dk to the nearest neighbor cluster centre. For example, the surrounding region is defined by a d-ball of radius less than or equal to dk/2 centred on the cluster centre.

The method may comprise a step of optimizing the kernel bandwidth H for the kernel density estimation. In one example, the kernel bandwidth H is optimized by minimizing the asymptotic mean integrated standard error (AMISE) of the kernel density estimate. This avoids the need to searches for an optimal bandwidth exhaustively. Thus, it allows a faster estimation of the optimal kernel bandwidth thereby improving time efficiency of clustering.

In some embodiments, the object data is flow cytometry data or mass cytometry data, and the objects are cells. The plurality of parameters may comprise expression levels for a plurality of proteins.

According to a second expression, there is provided a computer system for automatically assigning class labels to objects, using object data indicative of a plurality of parameters associated with each object, the system comprising at least one processor and a data storage device storing program instructions, the program instructions being operative, upon being run by the processor to cause the processor to perform anyone of method of the above.

According to a third expression, there is provided a non-transitory computer-readable medium having stored thereon computer program instructions which are configured to, when executed by at least one processor, perform the method of any one of the method above.

According to a further expression, there is provided a system for automatically assigning class labels to objects, using object data indicative of a plurality of parameters associated with each object. The system comprises a class assignment component which is configured to:
(i) identify, from the object data or from a lower-dimensional encoding of the object data, a plurality of cluster centres in a d-dimensional space, each cluster centre corresponding to one of the class labels;
(ii) for respective cluster centres, determine a surrounding region based on a nearest neighbor cluster centre, and assigning the respective class label to objects within the surrounding region;
(iii) generate a predictive model using the object data, or the lower-dimensional encoding of the object data, and the class labels of the assigned objects; and
(iv) assign class labels to unassigned objects using the predictive model.

The class assignment component may be configured to identify the cluster centres by: determining a kernel density estimate from the object data; and detecting peaks in the kernel density estimate, said peaks corresponding to the cluster centres.

In some embodiments, the class assignment component is configured to, prior to operation (i), apply dimensionality reduction to the object data to generate the lower-dimensional encoding of the object data. In one example, after the dimensionality reduction, the lower-dimensional encoding of the object data defines a 2-dimensional space.

The class assignment component may be configured to determine the surrounding region by determining a distance dk to the nearest neighbor cluster centre, and in one example, the surrounding region is a d-ball of radius less than or equal to dk/2 centred on the cluster centre.

The class assignment component may be configured to optimize the kernel bandwidth H for the kernel density estimation. In one example, the class assignment component is configured to optimize H by minimizing the asymptotic mean integrated standard error (AMISE) of the kernel density estimate.

The object data may be flow cytometry data or mass cytometry data, and the objects may be cells. In some examples, the plurality of parameters comprise expression levels for a plurality of proteins.

### BRIEF DESCRIPTION OF THE DRAWINGS

It will be convenient to further describe the present method with respect to the accompanying drawings that illustrate possible embodiments. Other embodiments are possible, and consequently the particularity of the accompanying drawings is not to be understood as superseding the generality of the preceding description of the method and/or system.

FIG. 1 is a flow chart illustrating a process of a clustering method known as ACCENSE.

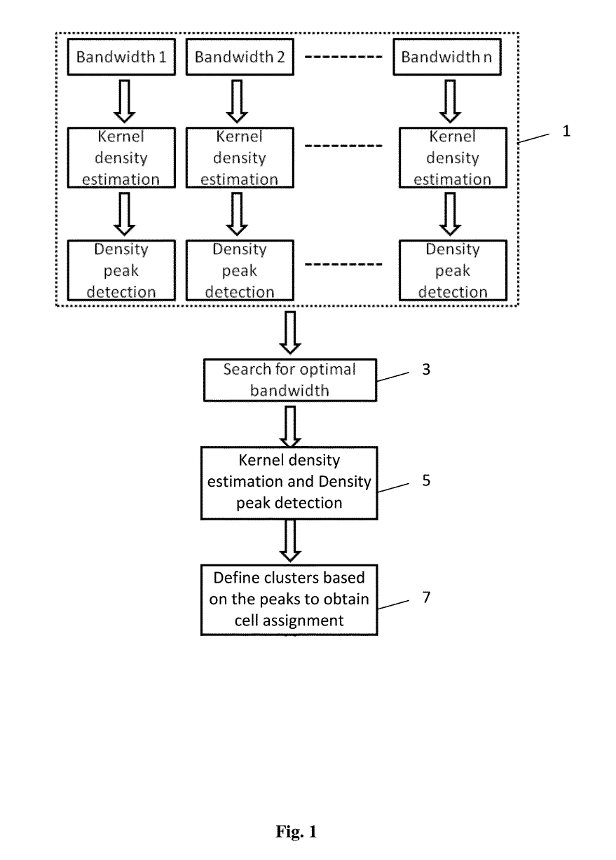

FIG. 2 is a flow chart of an exemplary method for analyzing flow cytometry and/or mass cytometry data.

FIG. 3 is a flow diagram of an exemplary method of performing class assignments of objects according to an embodiment.

FIG. 4 is a comparison of classification results performed by some of the known methods and a method of an embodiment of the present disclosure.

### DETAILED DESCRIPTION

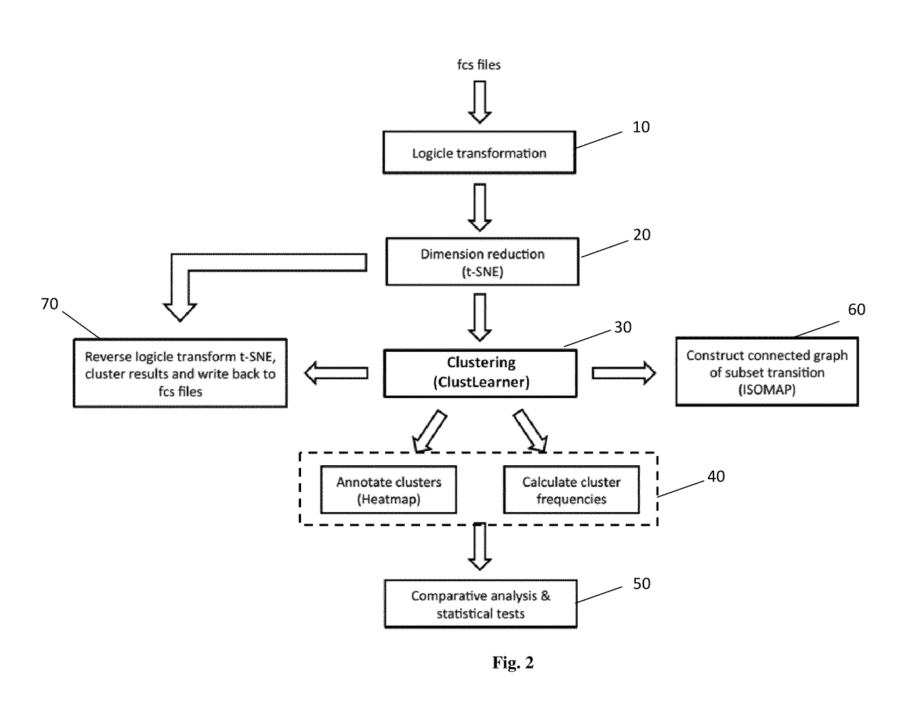

FIG. 2 shows an exemplary integrated data analysis pipeline for flow cytometry and mass cytometry data, which is termed Next Generation Single-Cell Analytical Tools 100 (NGSCAT). The NGSCAT 100 may be implemented by a computer system having a processor and/or hardware components configured to perform one or more of: pre-processing 10, dimensionality reduction 20, class assignment 30, cluster annotation 40, comparative analysis 50, visualization of subset progression 60 and post-processing 70. The computer system typically comprises a data storage device storing program instructions, the program instructions being operative upon being run by the processor to cause the processor to perform any one or more of the above operations, for example, the system has a class assignment component which performs class assignment operation 30 (and its sub-operations 302-318 as will be described below). For purposes of clarity the operations are enumerated. However, it will be understood by a skilled person that some or all of the elements or operations need not to be performed in the order implied by the enumeration.

### i) Operation 10: Pre-Processing

In this example, .FCS files (i.e. a data file standard for flow cytometry data) were imported into the R environment (a programming language and software environment for statistical computing and graphics) via the read .FCS function in the flowCore package. Intensity values of the marker expression were then logical-transformed, and markers specified by users were extracted for downstream analysis. Because the number of cell events can vary dramatically between different samples, we randomly sampled up to 10,000 cell events per sample to partially normalize the contribution of each sample.

### ii) Operation 20: Dimensionality Reduction

At operation 20, dimensionality reduction is applied to the flow cytometry data to generate a lower-dimensional encoding of the data. t-Distributed Stochastic Neighbor Embedding (t-SNE) is used for dimensionality reduction in this example. Briefly, t-SNE converts pair-wise distances between every two data points into a conditional probability that they are potential neighbors. It initializes the embedding by putting the low-dimensional data points in random locations that are adjusted in iteration, aiming to optimize the match of the conditional probability distributions between high and low dimensional spaces. For example, the optimization can be done using a gradient descent method to minimize a cost function defined by Kullback-Leibler divergences. In this embodiment, NGSCAT utilizes bh_tsne, an efficient implementation of t-SNE via Barnes-Hut approximations. bh_tsne was originally implemented and compiled in C++, but an interface function can be implemented to execute bh_tsne from R.

iii) Operation 30: Class Assignment

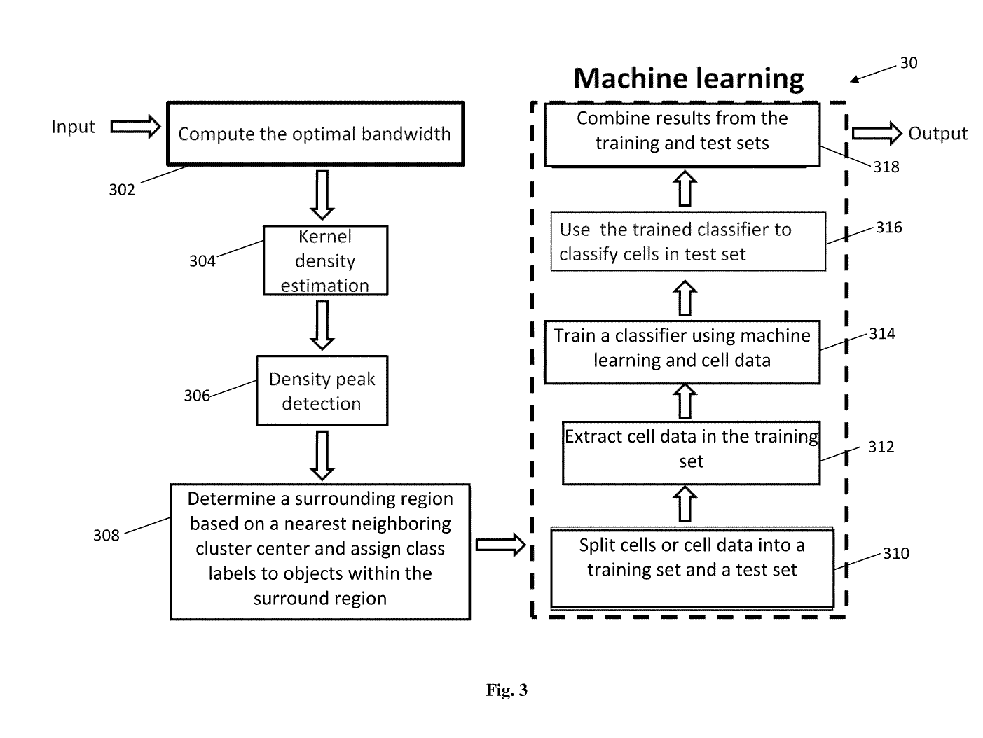

In this example, the class assignment (which is based on clustering) is performed using an algorithm referred to as “ClustLearner”. The embodiment is illustrated in detail by sub-operations 302-318 of FIG. 3.

### Sub-Operations 302-308

We assume all the data points are generated from N-component Gaussian mixture model

$${p}_{s} ( x ) = {\sum }_{i = 1}^{N} {α}_{i} φ ( x - {x}_{i} ) ,$$

where φ(x−xᵢ) is a Gaussian kernel centered at xᵢ and αᵢ is the corresponding weight. A kernel density estimate (KDE) p_{KDE}(x) is defined as a convolution of pₛ(x) by a kernel with bandwidth H. The key goal of KDE is to determine the bandwidth H such that the distance between p_{KDE} and pₛ(x) is minimized.

In sub-operation 302, the kernel bandwidth H for kernel density estimation is optimized. In a particular example, we obtain the optimum H by minimizing asymptotic mean integrated squared error (AMISE), defined as below,

$$AMISE = {( 4 π )}^{- d / 2} {\vert H \vert}^{- 1 / 2} {N}_{α}^{- 1} + \frac{1}{4} {d}^{2} \int {tr}^{2} \{ H {℘}_{p} ( x ) \} d x , \\ where$$

$$tr ( \cdot ) is the trace operator , {℘}_{{p}_{s}} ( x ) is a Hessian of {p}_{s} ( x ) , \\ and$$

$${N}_{α} = {( {\sum }_{i = 1}^{N} {α}_{i}^{2} )}^{- 1} .$$

This allows the optimal kernel bandwidth to be estimated efficiently, as compared to other known methods such as ACCENSE which obtains an optimal kernel bandwidth from an exhaustive search. Therefore, the present method which employs operation 302 significantly improves the time efficiency.

ClustLearner uses the calculated optimal bandwidth to perform clustering based on kernel density estimation at sub-operations 304-308, and it further incorporates machine learning methods (such as ones described later with respect to sub-operations 310-318) to improve the cluster analysis, as will be described below.

At sub-operation 304, the density-based clustering algorithm computes the 2D probability density of cells using a Gaussian kernel transform. A 2D peak-finding algorithm is employed at sub-operation 306 to identify local density maxima which correspond to the center of phenotypic subpopulations and a plurality of cluster centres are identified based on the local density maxima. For example, the local density maxima (e.g. the peaks) represent the respective cluster centres.

At sub-operation 308, a surrounding region is determined for each respective cluster centre, based on a nearest neighbor cluster centre. For example, for each peak (i.e. the assigned cluster centre), a peak of the nearest neighbor is identified and a distance dk between the two centres is calculated. The algorithm then draws a circle of radius dk/2 centered at the peak k, and assigns a class label associated with the cluster k to cells within the circle. Note that the above examples are given for illustrating clustering algorithms in a 2D space. In a variant, a higher dimension representation is possible and the surrounding region may be defined in a 3D or higher dimensional space.

### Sub-Operations 310-318

At sub-operations 310-318, ClustLearner incorporates machine-learning algorithms as a post-clustering process to improve the accuracy of clustering. The machine-learning algorithms are employed to train a classifier using the object data of objects which were assigned to the respective clusters. For example, the classifier learns the mapping from marker expression (e.g. protein expression patterns) of cells to cluster assignment. A predicative model is then obtained based on the trained classifier to make cluster predictions for those unclassified or undesignated cells during the clustering of sub-operation 308. The prediction may therefore be made based on similarity of patterns exhibited by cells (i.e. if we assume that cells with similar marker expressions originate from the same cluster). For example, unclassified cells sharing similar patterns of marker expressions with those of clustered cells are captured by the predicative model and are classified into the same cluster. The classifier may be obtained based on any machine learning algorithms such as Support Vector Machine, k-Nearest Neighbor, and/or Neural Networks etc.

Specifically, at sub-operations 310-312, cells are split into a training set and a test set and the associated cell data are identified. The training set contains associated cell data of those cells which have been assigned to a cluster, whereas the test set contains associated cell data of the cells which remain unclassified after the clustering operation (i.e. after sub-operation 308). The associated cell data may be, for example, protein expression values of the cells in the training set in respect of a plurality of proteins. At sub-operation 314, protein expression values of the cells in the training set are used to train the classifier. At sub-operation 316, the trained classifier is used for assigning the cells in the test set to the respective clusters. The assignment results of cells in the training set and in the test set may be combined to produce final cluster delineation for output as the class assignment results for all cells.

Therefore, the ClustLearner as described above allows cluster/class assignment to be performed for every single cell, and notably even for cells that are located at the boundaries between clusters. In particular, by incorporating the clustering outcome of the object data into machine learning as a post-clustering process, ClustLearner is able to identify cell population and to detect the boundaries of populations. This consequently allows the cell population and/or frequencies to be objectively compared. Although known algorithms which combines clustering and machine learning may exist, none of them is for improving clustering or class assignment based on clusters. Notably, although ClustLearner involves machine learning, no prior labeling of the cells is required. Rather, the input to the machine learning component is based on data from an un-supervised clustering method. This is different from any known algorithms.

Experiments are conducted to evaluate the performance of ClustLearner. The results have successfully demonstrated that ClustLearner has achieved a higher accuracy and also higher time efficiency (about eight times faster) as compared to ACCENSE.

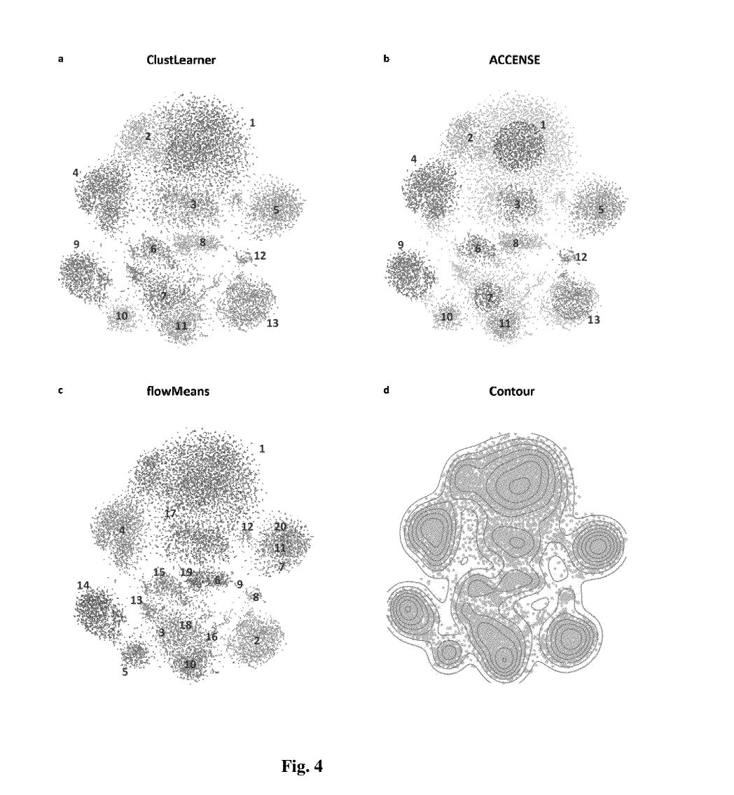

FIG. 4(a) illustrates the class assignment result performed by Clustlearner. As shown, ClustLearner is able to perform automatic subset identification satisfactorily, as it successfully recapitulates the cellular populations as illustrated in the contour plot of FIG. 4(d). More importantly, it demonstrates the capability of accurately estimating the boundaries of the cell clusters, which is critical for the calculation of cell population frequencies.

In contrast, as shown in FIG. 4(b), ACCENSE failed to identify the boundaries between populations, especially when neighboring populations were closely related. For example, despite clusters 1 and 3 being found in close proximity, ACCENSE was only able to identify the centers of these clusters while leaving numerous surrounding cellular events unclassified (grey color dots in FIG. 4(b)). This would lead to an inaccurate estimation of population size and frequencies, as well as an exclusion of potentially important cellular populations from downstream analysis. These observations demonstrate that ClustLearner outperforms ACCENSE at least in its capability of detecting population boundaries.

ClustLearner was also compared with flowMeans, a top ranking algorithm from the FlowCAP competition of population identification methods. As shown in FIGS. 4(a) and 4(c), ClustLearner (FIG. 4(a)) is able to segregate clusters 1, 3 and 4, whereas flowMeans (FIG. 4(c)) failed to discriminate these three clusters and instead classified them as one population. Although cluster 1 and 3 are closely related populations of cells, they have differential expression patterns of a marker IL2. Cluster 4 can also be distinguished from cluster 1 and 3 by the expression patterns of several markers including TNFa, CD38, CCR7, CD45RA and CD95. On the other hand, flowMeans represents one of the cell populations by several clusters. For example, cluster 5 identified by Clustlearner was represented by three clusters 7, 11 and 20 identified by flowMeans. The above shows that ClustLearner provides better segregations of cell populations than flowMeans.

Tables 1 and 2 below provide a quantitative assessment of the performance of ClustLearner. Manual gating was used as the gold standard for the assessment. Precision, recall and F-measure of ClustLearner and ACCENSE were calculated, respectively. The manual gating was performed by an experienced CyTOF user who used the FlowJo software to manually gate five cell populations including Natural Killer (NK), Natural Killer T (NKT), gamma-delta T (gdT), CD4 and CD8 T cells.

As shown in FIGS. 4(a) and 4(b), both ClustLearner and ACCENSE identified 13 clusters, among which cluster 1, 2, 3 and 4 are annotated as CD4 T cells, cluster 5, 6, 7, 9 are annotated as CD8 T cells, cluster 9 and 10 are annotated as gdT cells, cluster 11 is annotated as NKT cells, and cluster 12 and 13 are annotated as NK cells. The annotation may be based on different marker expressions characteristics, such as expression levels, of the cells in the respective cluster, as will be described below. For all the five cell populations, we calculated F-measure, the harmonic mean of precision and recall. As evident from Table 1, the F-measure of ClustLearner is higher than ACCENSE for all the five populations.

The time efficiency of ClustLearner and ACCENSE was also compared. As shown in Table 2, ClustLearner is about as eight times as fast compared to ACCENSE.

TABLE 1
Assessment of the performance of ClustLearner and Accense

| | | ClustLearner | | | | | F- | Accense | | True | | | |
|---|---|---|---|---|---|---|---|---|---|---|---|---|---|
| Gate | Count | cluster | Count | True positive | Precision | recall | measure | cluster | Count | positive | Precision | Recall | F-measure |
| CD4 | 4615 | CD4 | 4618 | 4395 | 0.95 | 0.95 | 0.95 | CD4 | 2864 | 2717 | 0.95 | 0.59 | 0.73 |
| | | (1, 2, 3, 4) | | | | | | (1, 2, 3, 4) | | | | | |
| CD8 | 2249 | CD8 | 2682 | 2153 | 0.80 | 0.96 | 0.87 | CD8 | 2029 | 1775 | 0.87 | 0.79 | 0.83 |
| | | (5, 6, 7, 8) | | | | | | (5, 6, 7, 8) | | | | | |
| gdT | 1045 | gdT (9, 10) | 1196 | 988 | 0.83 | 0.95 | 0.88 | gdT (9, 10) | 1105 | 943 | 0.85 | 0.90 | 0.88 |
| NKT | 1302 | NKT (11) | 700 | 663 | 0.95 | 0.51 | 0.66 | NKT (11) | 458 | 439 | 0.96 | 0.34 | 0.50 |
| NK | 958 | NK (12, 13) | 973 | 947 | 0.97 | 0.99 | 0.98 | NK (12, 13) | 734 | 727 | 0.99 | 0.76 | 0.86 |
| | | | | | | | | unclassified | 2979 | | | | |
| total | 10169 | total | 10169 | | | | | total | 10169 | | | | |

TABLE 2
Time efficiency comparison of ClustLearner and ACCENSE

| | ClustLearner | ACCENSE |
|---|---|---|
| Time | 210 seconds | 1669 seconds |

### iv) Cluster Annotation 40

At operation 40, cluster annotations are performed to examine whether the clusters automatically determined at operation 30 represent biologically meaningful cell populations. In this example, the individual clusters were annotated by using heatmaps.

Cell events were grouped by clusters and the median intensity values were calculated per cluster for every marker. Heatmaps visualizing the median expression of every marker in every cluster were generated with no scaling on the row or column direction. Hierarchical clustering was generated using Euclidean distance and complete agglomeration method. The heatmaps were used to interrogate marker expression to identify markers characteristics defining each of the clusters. Based on this, the individual clusters were designated as one of previously described or unknown populations based on prior knowledge on marker expression characteristics associated with different types of cells. For example, ClustLearner identifies cluster 1, 2, 3 and 4, which are then determined to be associated with highly expressed CD4 T cell markers such as CD3 and CD4, using heatmap visualization. Accordingly, these clusters are designated as representing CD4 T cells. Since some markers have high background signals, the frequency heatmap was generated based on frequencies of positive populations, as an alternative to the intensity heatmaps. The FCS files with cluster coordinates obtained by Clustlearner were imported into the FlowJo software and gating was carried out for positive populations. Frequencies of positive populations in each cluster were calculated and plotted in the frequency heatmap.

### v) Comparative Analysis and Statistical Tests 50

Studies on the abundance or cell frequencies of the respective clusters may be performed for sample (e.g. tissue samples) analysis. For example, a deviation of a certain cell population or subpopulation from a standard range may be indicative of a diseased or healthy state of the sample.

Unlike principal component analysis (PCA), both t-SNE and ISOMAP are non-parametric dimensionality reduction techniques, which prevent us from running an exact out-of-sample extension. An independent analysis of two similar samples will result in very different maps in a low dimensional space. Therefore, the above operations 10-40 were performed on cells combined from all the different samples in one experiment. A trellis visualization of the t-SNE map was then generated to visually identify the differences between samples. The frequencies of clusters were calculated on a per sample basis and a heatmap together with a dendrogram was plotted to illustrate the differences of cell subset frequencies. The grouping of samples was shown by the clustering dendrogram on samples. Based on the cluster analysis, t-test and BH correction (i.e. Barnes-Hut implementation of t-SNE) were run on cluster frequencies to identify which clusters have significantly different frequencies between different groups of samples.

### vi) Construction of Subset Transition Graph 60

Representations of cell state transition can be obtained by using the present method. In particular, in contrast to t-SNE, ISOMAP retains a continuum of transitional cell states, and the relative position of different cell states reflects their continuous relationship. Here the ISOMAP in combination with the t-SNE and ClustLearner are utilized to construct a graph in which nodes represent cell states and edges connecting nodes represent the state transition.

The data was downsampled by randomly selecting a comparable number of cell events from each of the clusters that were identified by ClustLearner. The sampled cell events were pooled and subjected to the ISOMAP dimensionality reduction. On the first two ISOMAP dimensions, nodes were placed at the centroid of each cluster and the inter-cluster continuum was used to draw edges connecting proximate clusters. The resulting connected graph provides information about the relationship between cell populations or even spatiotemporal phenotypic progression and the state transition. Along the first and second ISOMAP dimensions, 100 bins of equal intervals were generated and calculated the median intensities of markers expressed by cells within each bin. Smoothed curves may then plotted using the R package LOWESS to show the progressive phenotypic change.

vii) Post-Processing 70

The cluster assignment of each cell was coded into a two-dimensional coordinate system that was then inverse-logicle transformed. Similarly, the coordinates of the s-SNE map was inverse-logicle transformed, and the same was done for PCA and ISOMAP. The cluster coordinates, together with the t-SNE, PCA and ISOMAP coordinates, were added to the .FCS files as additional parameters. In other words, data and analysis output can be stored in the .FCS file for subsequent follow-ups, if necessary. For example, the populations of interest which were gated manually and those gated on the 2D PCA, ISOMAP or t-SNE plots can be overlaid using the FlowJo software to investigate whether the clusters identified by the latter represent biologically meaningful cell populations, or to identify types of markers which can be used to sort or characterize newly discovered cell types.

Whilst example embodiments of the invention have been described in detail, many variations are possible within the scope of the invention as will be clear to a skilled reader.

1. A method of automatically assigning class labels to objects, using object data indicative of a plurality of parameters associated with each object, the method comprising:
(i) identifying, from the object data or from a lower-dimensional encoding of the object data, a plurality of cluster centres in a d-dimensional space, each cluster centre corresponding to one of the class labels;
(ii) for respective cluster centres, determining a surrounding region based on a nearest neighbor cluster centre, and assigning the respective class label to objects within the surrounding region;
(iii) generating a predictive model using the object data, or the lower-dimensional encoding of the object data, and the class labels of the assigned objects; and
(iv) assigning class labels to unassigned objects using the predictive model.

2. The method according to claim 1, wherein the cluster centres are identified by: determining a kernel density estimate from the object data; and detecting peaks in the kernel density estimate, said peaks corresponding to the cluster centres.

3. The method according to claim 1, further comprising, prior to operation (i), applying dimensionality reduction to the object data to generate the lower-dimensional encoding of the object data.

4. The method according to claim 3, wherein after the dimensionality reduction, the lower-dimensional encoding of the object data defines a 2-dimensional space.

5. The method according to claim 1, wherein the surrounding region is determined by determining a distance dk to the nearest neighbor cluster centre, and wherein the surrounding region is a d-ball of radius less than or equal to dk/2 centred on the cluster centre.

6. The method according to claim 2, comprising optimizing the kernel bandwidth H for the kernel density estimation.

7. The method according to claim 6, wherein H is optimized by minimizing the asymptotic mean integrated standard error (AMISE) of the kernel density estimate.

8. The method according to claim 1, wherein the object data is flow cytometry data or mass cytometry data, and wherein the objects are cells.

9. The method according to claim 8, wherein the plurality of parameters comprises expression levels for a plurality of proteins.

10. A computer system for automatically assigning class labels to objects, using object data indicative of a plurality of parameters associated with each object, the computer system comprising at least one processor and a data storage device storing program instructions, the program instructions being operative, upon being run by the processor to cause the processor to perform which is configured to:
(i) identify, from the object data or from a lower-dimensional encoding of the object data, a plurality of cluster centres in a d-dimensional space, each cluster centre corresponding to one of the class labels;
(ii) for respective cluster centres, determine a surrounding region based on a nearest neighbor cluster centre, and assigning the respective class label to objects within the surrounding region;
(iii) generate a predictive model using the object data, or the lower-dimensional encoding of the object data, and the class labels of the assigned objects; and
(iv) assign class labels to unassigned objects using the predictive model.

11. The computer system according to claim 10, wherein the data storage device stores program instructions operative upon being run by the processor to cause the processor to identify the cluster centres by: determining a kernel density estimate from the object data; and detecting peaks in the kernel density estimate, said peaks corresponding to the cluster centres.

12. The computer system according to claim 10, wherein the data storage device stores program instructions operative upon being run by the processor to cause the processor to, prior to operation (i), apply dimensionality reduction to the object data to generate the lower-dimensional encoding of the object data.

13. The computer system according to claim 12, wherein after the dimensionality reduction, the lower-dimensional encoding of the object data defines a 2 dimensional space.

14. The computer system according to claim 10, wherein the data storage device stores program instructions operative upon being run by the processor to cause the processor to determine the surrounding region by determining a distance dk to the nearest neighbor cluster centre, and wherein the surrounding region is a d-ball of radius less than or equal to dk/2 centred on the cluster centre.

15. The computer system according to claim 11, wherein the data storage device stores program instructions operative upon being run by the processor to cause the processor to optimize the kernel bandwidth H for the kernel density estimation.

16. The computer system according to claim 15, wherein the data storage device stores program instructions operative upon being run by the processor to cause the processor to optimize H by minimizing the asymptotic mean integrated standard error (AMISE) of the kernel density estimate.

17. The computer system according to claim 10, wherein the object data is flow cytometry data or mass cytometry data, and wherein the objects are cells.

18. The computer system according to claim 17, wherein the plurality of parameters comprises expression levels for a plurality of proteins.

19. A non-transitory computer-readable medium having stored thereon computer program instructions which are configured to, when executed by at least one processor, perform operations of:
(i) identify, from the object data or from a lower-dimensional encoding of the object data, a plurality of cluster centres in a d-dimensional space, each cluster centre corresponding to one of the class labels;
(ii) for respective cluster centres, determine a surrounding region based on a nearest neighbor cluster centre, and assigning the respective class label to objects within the surrounding region;
(iii) generate a predictive model using the object data, or the lower-dimensional encoding of the object data, and the class labels of the assigned objects; and
(iv) assign class labels to unassigned objects using the predictive model.
